(19) United States
(12) Patent Application Publication
(10) Pub. No.: US 2011/0093692 A1
(43) Pub. Date: Apr. 21, 2011

(54) METHOD OF UPDATING IDENTIFICATION DATA OF A COMPUTER SYSTEM AND RELATED COMPUTER SYSTEM

(76) Inventors: Ming-Hung Tsai, Taipei Hsien (TW); Yu-Ping Chen, Taipei Hsien (TW)

(21) Appl. No.: 12/874,227

(22) Filed: Sep. 2, 2010

(30) Foreign Application Priority Data
Oct. 19, 2009 (TW) 098135251

(51) Int. Cl. G06F 15/177

(52) U.S. Cl. 713/2

(57) ABSTRACT

A method of updating an identification datum of a computer system includes starting BIOS when the computer system is powered on, starting a power on self test (POST) program in BIOS, the POST program detecting whether a memory unit stores an identification datum not being input yet, determining whether to input the identification datum into the computer system according to a result of detecting whether the memory unit stores the identification datum by the POST program.

### BACKGROUND OF THE INVENTION

1. Field of the Invention

The present invention relates to a method of updating identification data of a computer system and a related computer system, and more particularly, to a method of updating identification data of a computer system when the BIOS is started and a related computer system.

2. Description of the Prior Art

A computer system becomes a necessary information tool in the modern society. Applications of a desktop personal computer, a notebook computer, and a host are utilized widespread, so that corresponding hardware devices and software programs are advanced complicatedly. A basic input/output system (BIOS) is the basic program code in the computer system. The BIOS includes functions of a power on self test (POST) program for detecting operations of a central processing unit and controllers, initializing of a memory, a chip on a main board, a displaying card, and related electronic components, storing a datum to record settings of each electronic component, and operating a daemon database to provide an interrupted daemon called by an operating system (OS) or an application program. Therefore, the BIOS is for initializing the hardware device, detecting functions of the hardware device, and driving the OS in starting process of the computer system. Computer firmware utilizes the POST program to ensure a complete detection of the hardware system, and a detecting result is displayed on an output interface controlled by the computer firmware. When the above-mentioned steps are finished, the BIOS can load the OS so that a user can operate the hardware devices and the software programs of the computer system.

Generally, an identification datum, such as serial number code (SN code) and universally unique identifier (UUID), must be input to the computer system in a factory. However, a conventional method stores the identification datum to a non volatile storage (NVS) of the BIOS by an input device driven with the OS, such as a keyboard and a bar code gun, after the OS is started. The conventional method not only spends more labor hours in the factory, but also makes a mistake that an operator forgets updating the identification datum easily because the computer system does not provide a prompting message. Thus, design of a method for updating the identification datum quickly and for preventing the operator from forgetting updating the identification datum in the factory is an important issue in the computer system industry.

### SUMMARY OF THE INVENTION

The present invention provides a method of updating identification data of a computer system when the BIOS is started and a related computer system for solving above drawbacks.

According to the claimed invention, a method of updating an identification datum of a computer system includes starting a basic input/output system when the computer system is powered on, starting a power on self test program in the BIOS, detecting whether a memory unit stores the identification datum not being input yet by the POST program, and determining whether to input the identification datum into the computer system according to a result of detecting whether the memory unit stores the identification datum by the POST program.

According to the claimed invention, displaying an input window to request to enter the identification datum when the POST program detects the memory unit does not store the identification datum.

According to the claimed invention, finishing the POST program when the POST program detects the memory unit stores the identification datum.

According to the claimed invention, determining whether the identification datum is input correctly by the POST program, and determining whether to store the identification datum into the memory unit according to a result of determining whether the identification datum is input correctly by the POST program.

According to the claimed invention, storing the identification datum into the memory unit when the POST program determines the identification datum is input correctly.

According to the claimed invention, detecting whether the memory unit stores another identification datum not being input yet by the POST program after the POST program determines the identification datum is input correctly and the identification datum is stored into the memory unit.

According to the claimed invention, displaying an input window to request to enter the identification datum when the POST program determines the identification datum is not input correctly.

According to the claimed invention, starting a communication transmission interface for transmitting the identification datum to the computer system.

According to the claimed invention, a computer system includes a non volatile storage for storing a basic input/output system, the BIOS comprising a power on self test program, a memory unit for storing an identification datum, an input module, and a control device electrically connected to the non volatile storage, the memory unit, and the input module for starting the BIOS and the POST program when the computer system is powered on, controlling the POST program to detect whether the memory unit stores the identification datum not being input yet, and controlling whether to input the identification datum by the input module according to a result of detecting whether the memory unit stores the identification datum by the POST program.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system capable of updating an identification datum according to a preferred embodiment of the present invention.

FIG. 2 is a flow chart of updating the identification datum of the computer system according to the preferred embodiment of the present invention.

### DETAILED DESCRIPTION

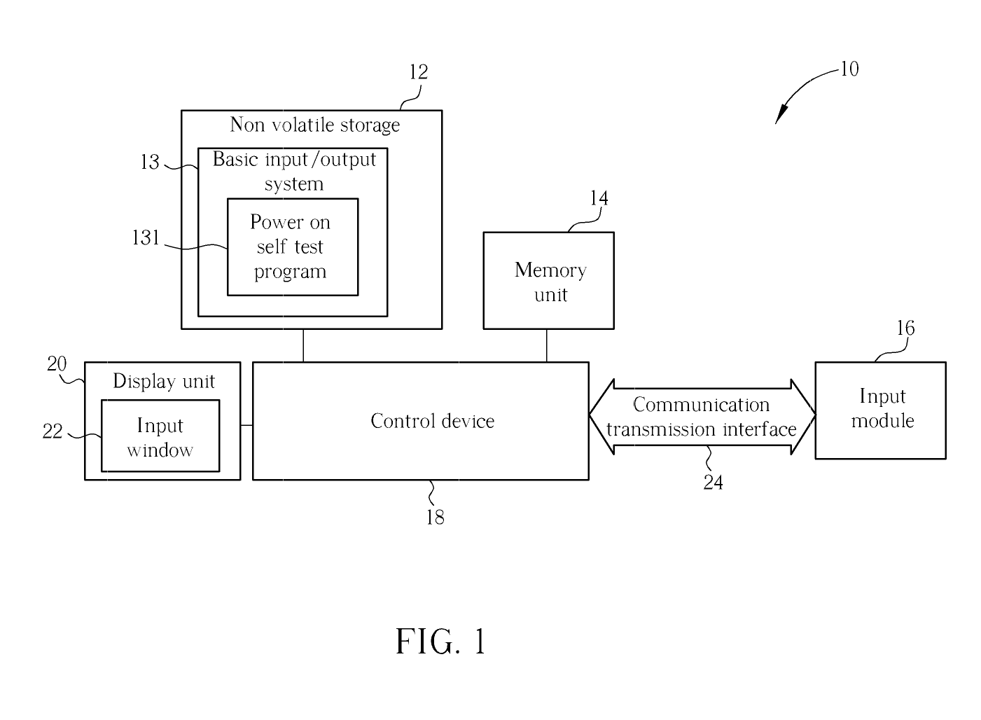

Please refer to FIG. 1. FIG. 1 is a functional block diagram of a computer system 10 capable of updating an identification datum according to a preferred embodiment of the present invention. The computer system 10 can be a portable computer system, such as a notebook computer or a desktop computer system. The computer system 10 includes a non volatile storage (NVS) 12, a memory unit 14, an input module 16, and a control device 18 electrically connected to the NVS 12, the memory unit 14, and the input module 16. The NVS 12 is for storing a basic input/output system (BIOS) 13. The BIOS 13 includes a power on self test (POST) program 131 for executing an inspection of computer hardware, such as a central processing unit, a controller, and so on. The BIOS 13 is started after the computer system 10 is powered on, and then the BIOS 13 starts the POST program 131 for next operation. The memory unit 14 is for storing the identification datum. For example, the identification datum can be a universally unique identifier (UUID) or a serial number code (SN code) of the computer system 10. The memory unit 14 can be integrated with the NVS 12. That is to day, the identification datum and the BIOS 13 can be stored in different access regions of the NVS 12. Further, the memory unit 14 and the NVS 12 can be different storage modules, and the identification datum and the BIOS 13 can be stored in the different storage modules, respectively. The input module 16 can be a human computer interface (HCI) device for inputting the identification datum, such as a bar code gun or a keyboard. The control device 18 can be a central processing unit or a microprocessor for starting the BIOS 13 and the POST program 131 when the computer system 10 is powered on, for controlling the POST program 131 to detect whether the memory unit 14 stores the identification datum not being input yet, and for controlling whether to input the identification datum by the input module 16 according to a detecting result of detecting whether the memory unit 14 stores the identification datum by the POST program 131. The memory unit 14 can stores a plurality of identification data. When the first identification datum is detected and input, the POST program 131 continuously detects whether other the identification data are input to the memory unit 14, so that the POST program 131 can execute a single detection for a single identification datum or multiple detections for the plurality of identification data.

In addition, the computer system 10 further includes a display unit 20 electrically connected to the control device 18. When the POST program 131 detects the memory unit 14 does not store the identification datum, the POST program 131 can further control the display unit 20 to display an input window 22 to request to enter the identification datum. On the other hand, when the POST program 131 detects the memory unit 14 stores the identification datum, the control device 18 can further end the POST program 131 to execute an operating system. The computer system 10 further includes a communication transmission interface 24 electrically connected to the input module 16 and the control device 18 for transmitting the identification datum input by the input module 16 to the control device 18. For example, the communication transmission interface can be a universal serial bus (USB).

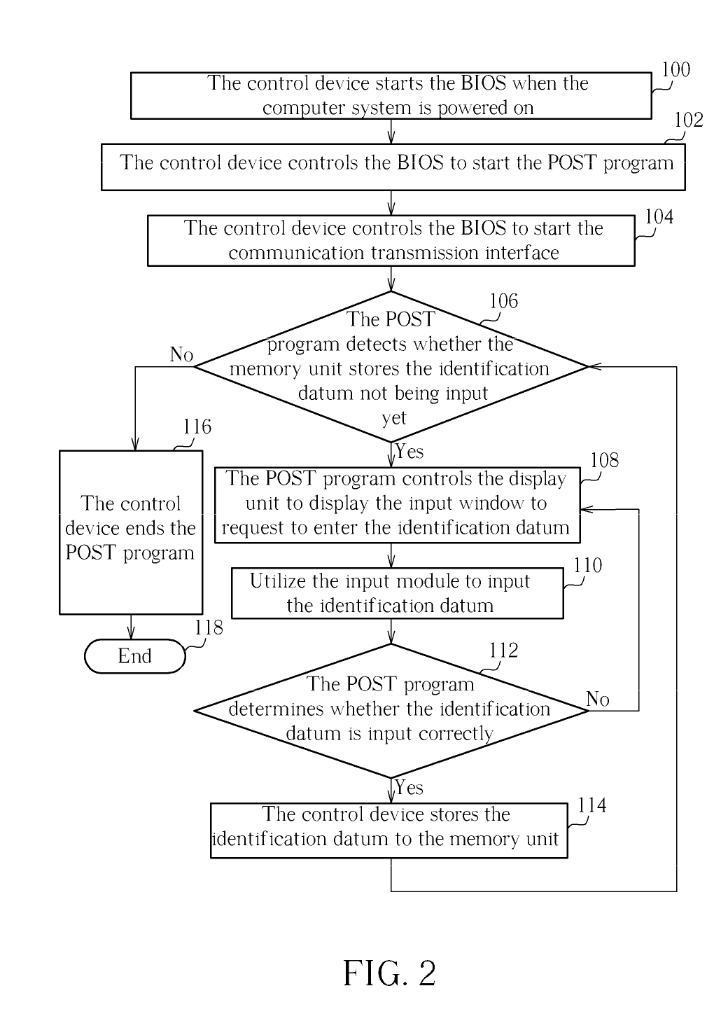

Please refer to FIG. 2. FIG. 2 is a flow chart diagram of updating the identification datum of the computer system 10 according to the preferred embodiment of the present invention. The method includes following steps.

Step 100: The control device 18 starts the BIOS 13 when the computer system 10 is powered on;

Step 102: The control device 18 controls the BIOS 13 to start the POST program 131;

Step 104: The control device 18 controls the BIOS 13 to start the communication transmission interface 24 so as to provide an interface for transmitting the identification datum input by the input module 16 to the control device 18;

Step 106: The POST program 131 detects whether the memory unit 14 stores the identification datum not being input yet. If yes, execute step 108. If no, execute step 116;

Step 108: The POST program 131 controls the display unit 20 to display the input window 22 to request to enter the identification datum;

Step 110: Utilize the input module 16 to input the identification datum;

Step 112: The POST program 131 determines whether the identification datum is input correctly. If no, go back to step 108. If yes, execute step 114;

Step 114: The control device 18 stores the identification datum to the memory unit 14 and then goes to step 106 to operate the POST program 131 to detect whether the memory unit 14 stores another identification datum not being input yet;

Step 116: The control device 18 ends the POST program 131;

Step 118: End.

Detailed description of above-mentioned steps is introduced as follows. First, the control device 18 loads and starts the BIOS 13 from the NVS 12 when the computer system 10 is powered on. The BIOS 13 starts the POST program 131 and the communication transmission interface 24, respectively. The POST program 131 can detect whether hardware connected to the control device 18 is operated correctly, such as the input module 16. The communication transmission interface 24 can transmit the identification datum input by the input module 16 to the control device 18. Next, the POST program 131 detects whether the memory unit 14 stores a predetermined identification datum not being input yet after the BIOS 13 starts the POST program 131 and the communication transmission interface 24, and determines whether to input the identification datum according to the detecting result. The memory unit 14 can be integrated with the NVS 12, which means the identification datum and the BIOS 13 can be stored in different access regions of the NVS 12. Arrangement of the access regions is not limited to the above-mentioned embodiment and depends on actual demand. When the POST program 131 detects the memory unit 14 does not store the predetermined identification datum not being input yet, it means the computer system 10 has finished updating of the identification datum, so that the control device 18 can end the POST program 131 so as to control the BIOS 13 for executing next procedure, such as executing the operating system. On the other hand, when the POST program 131 detects the memory unit 14 stores the predetermined identification datum not being input yet, which means the identification datum may fail to be stored to the memory unit 14 or the memory unit 14 may store a former identification datum or a wrong identification datum, the POST program 131 can control the display unit 20 to display the input window 22 so as to request a user, such as an operator in a factory, to enter the correct identification datum.

The user can utilize the input module 16 to enter the identification datum. For example, the input module 16 can be the bar code gun electrically connected to the communication transmission interface 24, such as inserting a connector of the bar code gun into the USB slot to actuate the bar code gun. The bar code gun can scan the identification datum automatically so that the user does not need to key in the identification datum. The input module 16 can further be the keyboard, so that the user can key in the code of the identification datum on the input window 22 by the keyboard manually. The identification datum can be the UUID or the SN code, so that the computer system 10 owns unique identification information. When the user utilizes the input module 16 to enter the identification datum on the input window 22, the POST program 131 detects whether the identification datum is input correctly and determines whether to store the identification datum to the memory unit 14 according to the detecting result. When the POST program 131 detects the identification datum is input correctly, the control device 18 can store the identification datum to the memory unit 14. When the POST program 131 detects the identification datum is input correctly and the identification datum is stored to the memory unit 14, the POST program 131 further detects whether the memory unit 14 stores another identification datum not being input yet, and determines whether to input the identification datum according to the detecting result. When the plurality of predetermined identification data is input correctly, the control device 18 can end the POST program 131 to finish the procedure of updating data of the BIOS 13, so as to enter the operating system to execute next processing. On the other hand, when the POST program 131 determines the identification datum is not input correctly, the POST program 131 displays the input window 22 again to request the user to enter the correct identification datum. After the user enters the identification datum, the POST program 131 repeats the above-mentioned steps, which the POST program 131 detects whether the identification datum is input correctly again, and determines whether to store the identification datum to the memory unit 14 according to the detecting result.

In conclusion, the method of updating the data of the BIOS 13 of the computer system 10 of the present invention can detect whether the identification datum in the memory unit 14 need to be updated when the computer system 10 executes the BIOS 13, determine whether the identification datum is correct after updating, and execute the corresponding procedure of updating the identification datum according to the detecting result. That is to say, the user can determine whether to utilize the input module 16 electrically connected to the control device 18 to update the identification datum via the communication transmission interface 24 according to the detecting result of detecting whether the memory unit 14 stores the identification datum not being input yet by the POST program 131. After that, the user determines whether to store the identification datum to the memory unit 14 according to the determining result of determining whether the identification datum is input correctly by the POST program 131.

Comparing to the prior art, the computer system of the present invention utilizes the POST program of the BIOS to detect a state of the identification datum in the memory unit directly when the BIOS is executed, to enter the identification datum selectively according to the detecting result, and to execute a confirmation procedure. Therefore, the present invention can update the identification datum when the computer system executes the BIOS, which is different from a conventional method of updating the identification datum after the operating system is started. The present invention can economize labor hours effectively and help the user to update the identification datum of the memory unit in the factory easily. The present invention not only can prevent an update procedure of the identification datum from failure when the computer system executes the operating system, but can also display the input window to remind the operator of entering the corresponding identification datum, so that accuracy of updating the identification datum of the computer system can be increased effectively.

Those skilled in the art will readily observe that numerous modifications and alterations of the device and method may be made while retaining the teachings of the invention.

What is claimed is:

1. A method of updating an identification datum of a computer system comprising:
starting a basic input/output system (BIOS) when the computer system is powered on;
starting a power on self test (POST) program in the BIOS;
detecting whether a memory unit stores the identification datum not being input yet by the POST program; and
determining whether to input the identification datum into the computer system according to a result of detecting whether the memory unit stores the identification datum by the POST program.

2. The method of claim 1 further comprising:
displaying an input window to request to enter the identification datum when the POST program detects the memory unit does not store the identification datum.

3. The method of claim 1 further comprising:
finishing the POST program when the POST program detects the memory unit stores the identification datum.

4. The method of claim 1 further comprising:
determining whether the identification datum is input correctly by the POST program; and
determining whether to store the identification datum into the memory unit according to a result of determining whether the identification datum is input correctly by the POST program.

5. The method of claim 4 further comprising:
storing the identification datum into the memory unit when the POST program determines the identification datum is input correctly.

6. The method of claim 5 further comprising:
detecting whether the memory unit stores another identification datum not being input yet by the POST program after the POST program determines the identification datum is input correctly and the identification datum is stored into the memory unit.

7. The method of claim 4 further comprising:
displaying an input window to request to enter the identification datum when the POST program determines the identification datum is not input correctly.

8. The method of claim 1 further comprising:
starting a communication transmission interface for transmitting the identification datum to the computer system.

9. The method of claim 8, wherein starting the communication transmission interface for transmitting the identification datum to the computer system comprises starting a universal serial bus (USB) for transmitting the identification datum to the computer system.

10. The method of claim 1, wherein the identification datum is a universally unique identifier code (UUID).

11. The method of claim 1, wherein the identification datum is a serial number code (SN code).

12. A computer system comprising:
a non volatile storage for storing a basic input/output system (BIOS), the BIOS comprising a power on self test (POST) program;
a memory unit for storing an identification datum;
an input module; and
a control device electrically connected to the non volatile storage, the memory unit, and the input module for starting the BIOS and the POST program when the computer system is powered on, controlling the POST program to detect whether the memory unit stores the identification datum not being input yet, and controlling whether to input the identification datum by the input module according to a result of detecting whether the memory unit stores the identification datum by the POST program.

13. The computer system of claim 12, further comprising:
a displaying unit, the control device further being for operating the POST program to control the displaying unit to display an input window to request to enter the identification datum when the POST program detects the memory unit does not store the identification datum.

14. The computer system of claim 12, wherein the control device is further for finishing the POST program when the POST program detects the memory unit stores the identification datum.

15. The computer system of claim 12, wherein the control device is further for controlling the POST program to determine whether the identification datum is input correctly, and is further for controlling whether to store the identification datum into the memory unit according to a result of whether the POST program determines the identification datum is input correctly.

16. The computer system of claim 15, wherein the control device is further for storing the identification datum into the memory unit when the POST program determines the identification datum is input correctly.

17. The computer system of claim 16, wherein the control device is further for operating the POST program to detect whether the memory unit stores another identification datum not being input yet after the POST program determines the identification datum is input correctly and the identification datum is stored into the memory unit.

18. The computer system of claim 15, further comprising:
a displaying unit, the control device further being for operating the POST program to control the displaying unit to display an input window to request to enter the identification datum when the POST program determines the identification datum is not input correctly.

19. The computer system of claim 12, further comprising:
a communication transmission interface electrically connected to the input module and the control device for transmitting the identification datum input by the input module to the control device.

20. The computer system of claim 12, wherein the memory unit is integrated with the non volatile storage.
